(19) United States
(12) Patent Application Publication
(10) Pub. No.: US 2025/0085578 A1
(43) Pub. Date: Mar. 13, 2025

(54) DISPLAY SCREEN ASSEMBLY AND DISPLAY SCREEN

(71) Applicant: SHENZHEN HITEVISION TECHNOLOGY CO., LTD., Shenzhen (CN)

(72) Inventors: Xulai HE, Shenzhen (CN); Chun WANG, Shenzhen (CN); Xuhu HUANG, Shenzhen (CN)

(73) Assignee: SHENZHEN HITEVISION TECHNOLOGY CO., LTD., Shenzhen (CN)

(21) Appl. No.: 18/956,047

(22) Filed: Nov. 22, 2024

Related U.S. Application Data
(63) Continuation of application No. PCT/CN2023/090678, filed on Apr. 25, 2023.

(30) Foreign Application Priority Data
Dec. 12, 2022 (CN) 202223346516.0
Dec. 15, 2022 (CN) 202223376469.4

(51) Int. Cl. G02F 1/1333; G02F 1/1339

(52) U.S. Cl. CPC G02F 1/133331; G02F 1/1339

(57) ABSTRACT

A display screen assembly and a display screen. The display screen assembly comprises: a cover plate; a liquid crystal panel; and a first support frame comprising a first support surface and a second support surface, wherein the first support surface is higher than the second support surface; the first support surface supports the cover plate, the second support surface supports the liquid crystal panel, and the cover plate covers an outer side of the liquid crystal panel; a first elastic adhesive member is provided between the first support surface and the cover plate, a second elastic adhesive member is provided between the second support surface and the liquid crystal panel, and a first sealing member is provided between the liquid crystal panel and the cover plate.

### CROSS REFERENCE TO RELATED APPLICATIONS

The present application is a continuation application of International Application No. PCT/CN2023/090678 filed on Apr. 25, 2023, which claims priority to Chinese Patent Application No. 202223346516.0 entitled “DISPLAY SCREEN ASSEMBLY AND DISPLAY SCREEN” filed on Dec. 12, 2022, and also claims priority to Chinese Patent Application No. 202223376469.4 entitled “DISPLAY SCREEN” filed on Dec. 15, 2022, all of which are incorporated by reference in their entireties.

### TECHNICAL FIELD

The present application relates to the field of display technology, specifically to a display screen assembly and a display screen.

### BACKGROUND

An existing display screen usually includes a cover plate, a liquid crystal panel, and a support frame. The cover plate and the liquid crystal panel are fixed on the support frame respectively, and the cover plate covers and protects the liquid crystal panel.

### SUMMARY

In a first aspect, embodiments of the present application provide a display screen assembly, including: a cover plate; a liquid crystal panel; and a first support frame including a first support surface and a second support surface, where the first support surface is higher than the second support surface; the first support surface supports the cover plate, the second support surface supports the liquid crystal panel, and the cover plate covers an outer side of the liquid crystal panel; a first elastic adhesive member is provided between the first support surface and the cover plate, a second elastic adhesive member is provided between the second support surface and the liquid crystal panel, and a first sealing member is provided between the liquid crystal panel and the cover plate.

According to embodiments of the first aspect of the present application, the first support frame includes a first step portion and a second step portion, the first step portion is higher than the second step portion, the first support surface is located at the first step portion, and the second support surface is located at the second step portion.

According to embodiments of the first aspect of the present application, the first step portion further includes a first vertical surface, a first buffer member is provided between the first vertical surface and the cover plate, and the first buffer member is bonded to the first vertical surface.

According to embodiments of the first aspect of the present application, the first buffer member is a rubber pad or foam.

According to embodiments of the first aspect of the present application, the second step portion further includes a second vertical surface, a second buffer member is provided between the second vertical surface and the liquid crystal panel, and the second buffer member is bonded to the second vertical surface.

According to embodiments of the first aspect of the present application, the second buffer member is a rubber pad or foam.

According to embodiments of the first aspect of the present application, the first sealing element is foam.

According to embodiments of the first aspect of the present application, both the first elastic adhesive member and the second elastic adhesive member are double-sided adhesive tapes.

According to embodiments of the first aspect of the present application, a gap between the liquid crystal panel and the cover plate is not more than 1.26 mm.

According to embodiments of the first aspect of the present application, the first support surface extends to an outer wall of the first support frame, and an outer edge of the cover plate is coplanar with the outer wall of the first support frame.

According to embodiments of the first aspect of the present application, a first groove is provided on the first support surface, a second groove is provided on the second support surface, and length directions of the first groove and the second groove are consistent with a length direction of the first support frame; the first elastic adhesive member is disposed in the first groove, and the second elastic adhesive member is disposed in the second groove.

According to embodiments of the first aspect of the present application, the first groove has a width of not less than 2.5 mm and a depth of 0.2 to 0.6 mm; and the second groove has a width of not less than 2.5 mm and a depth of 0.2 to 0.5 mm.

According to embodiments of the first aspect of the present application, a relationship between an adhesive area S of the second elastic adhesive member and a dimension A of the liquid crystal panel satisfies: S≥343A, where S is in mm² and A is in inches.

According to embodiments of the first aspect of the present application, a relationship between a thickness H of the second elastic adhesive member and the dimension A of the liquid crystal panel satisfies: H≥0.011A, where His in mm and A is in inches.

According to embodiments of the first aspect of the present application, the first elastic adhesive member has a Shore hardness of 30 to 70 degrees, and an adhesive is provided on a bottom surface or double sides of the first elastic adhesive member.

According to embodiments of the first aspect of the present application, the gap between the liquid crystal panel and the cover plate is less than or equal to 1.26 mm; the gap between the first support surface and the cover plate is 0.2 to 1 mm; the height difference between the first support surface and the second support surface is 2.4 to 3.4 mm; and a polarizing layer of the liquid crystal panel has a haze of 20% to 30%, or both the inner and outer surfaces of the cover plate have a haze of 3% to 20%.

In a second aspect, embodiments of the present application provide a display screen, including: the display screen assembly in embodiments of the first aspect of the present application; a second support frame surrounding peripheral edges and a back surface of the display screen assembly, where the second support frame is directly or indirectly fixedly connected to the first support frame; and a backlight module fixed to a bottom of the second support frame or to a back of the first support frame.

In a third aspect, embodiments of the present application provide a display screen, including: the display screen assembly in embodiments of the first aspect of the present application; and a second support frame surrounding the periphery of the first support frame and pressing outer surface edges of the cover plate, where the second support frame has an inner wall; the first support frame is a square support frame composed of four borders, and the outer wall of the first support frame and the outer edge of the cover plate are opposite to the inner wall; the first buffer member is provided between the inner wall and the outer edge of the cover plate.

According to embodiments of the third aspect of the present application, the display screen further includes: a backlight module located below the liquid crystal panel; and a shell, where the backlight module is fixed between the shell and the liquid crystal panel; where the first support frame further includes a third support surface opposite to the second support surface; a third elastic adhesive member is provided between the third support surface and the backlight module; the third support surface has a recessed portion, and at least a portion of the third elastic adhesive member is located in the recessed portion; the distance between a bottom surface of the third elastic adhesive member and an outer surface of the backlight module is less than or equal to 0.4 mm.

According to embodiments of the third aspect of the present application, a relationship between the dimension A of the liquid crystal panel and a gap h between the liquid crystal panel and the backlight module satisfies: 9.2≤A/h≤18.5, where A is in inches and h is in mm.

### BRIEF DESCRIPTION OF THE DRAWINGS

The present application can be better understood from the following description of specific implementations in conjunction with the accompanying drawings. By reading the following detailed description of non-limiting embodiments with reference to the accompanying drawings, other features, objectives, and advantages of the present application will become more apparent. The same or similar reference numerals represent the same or similar features.

FIG. 1 is a schematic structural view of a display screen assembly according to an embodiment of the present application.

FIG. 2 is a schematic structural view of a first support frame of the display screen assembly according to an embodiment of the present application.

FIG. 3 is another schematic structural view of the display screen assembly according to an embodiment of the present application.

FIG. 4 is a schematic structural view of a display screen according to an embodiment of the present application.

FIG. 5 is another schematic structural view of a display screen according to an embodiment of the present application.

FIG. 6 is a partial exploded view of the display screen according to an embodiment of the present application.

### LIST OF REFERENCES

1. First support frame; 11. First elastic adhesive member; 12. Second elastic adhesive member; 13. First step portion; 14. Second step portion; 15. First groove; 16. Second groove;
17. Third groove; 18. Third elastic adhesive member;
2. Second support frame;
3. Cover plate; 31. First sealing member; 32. First buffer member;
4. Liquid crystal panel; 41. Second buffer member;
5. Backlight module;
6. Shell;
S1. First support surface; S2. Second support surface; S3. Third support surface; S4. First vertical surface; S5. Second vertical surface.

### DETAILED DESCRIPTION

The features and exemplary embodiments of various aspects of the present application will be described in detail below. The following detailed description discloses many specific details for a comprehensive understanding of the present application. However, it is apparent to those skilled in the art that the present application can be implemented without some of these specific details. The following description of embodiments is only to provide a better understanding of the present application by illustrating examples of the present application. The present application is by no means limited to any specific configuration and algorithm provided below, but covers any modification, substitution, and improvement of elements, components, and algorithms without departing from the spirit of the present application. In the accompanying drawings and the following description, well-known structures and techniques are not shown to avoid unnecessary ambiguity in the present application.

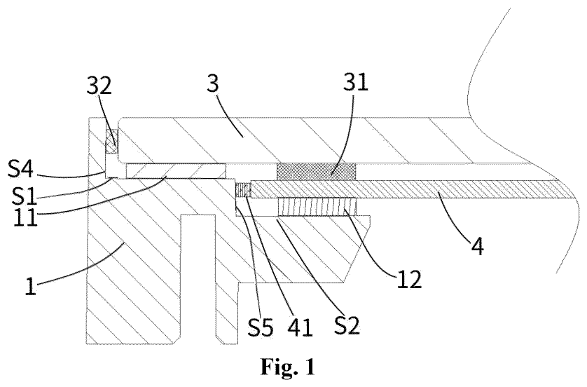

FIG. 1 is a schematic structural view of a display screen assembly according to an embodiment of the present application.

In a first aspect, with reference to FIG. 1, the present application provides a display screen assembly, including a cover plate 3, a liquid crystal panel 4, and a first support frame 1, where the first support frame 1 includes a first support surface S1 and a second support surface S2, the first support surface S1 is higher than the second support surface S2, the first support surface S1 supports the cover plate 3, the second support surface S2 supports the liquid crystal panel 4, and the cover plate 3 covers an outer side of the liquid crystal panel 4; a first elastic adhesive member 11 is provided between the first support surface S1 and the cover plate 3, a second elastic adhesive member 12 is provided between the second support surface S2 and the liquid crystal panel 4, and a first sealing member 31 is provided between the liquid crystal panel 4 and the cover plate 3.

Specifically, the liquid crystal panel 4 in the display screen assembly may be various liquid crystal panels 4 in existing technologies, and the cover plate 3 is usually a transparent glass cover plate, such as a tempered glass cover plate or a touch glass cover plate. The cover plate 3 is disposed on the outer side of the liquid crystal panel 4, and covers the liquid crystal panel 4 to protect the liquid crystal panel 4 as a core component of the display screen assembly.

The first support frame 1 may be a complete integrated enclosure frame, which completely surrounds and supports four sides of the cover plate 3 and the liquid crystal panel 4; or the first support frame may be divided into four parts disposed at four corners of the cover plate 3 and the liquid crystal panel 4 respectively, to support the cover plate 3 and the liquid crystal panel 4.

The first support frame 1 supports the cover plate 3 and the liquid crystal panel 4 through two adjacent steps. The surface of each step, parallel to the cover plate 3 or the liquid crystal panel 4, is a “support surface”, namely, the first support surface S1 or the second support surface S2. The first support surface S1 is higher than the second support surface S2. The first support surface S1 supports the cover plate 3, and the second support surface S2 supports the liquid crystal panel 4. In this case, the cover plate 3 is located on the outer side of the liquid crystal panel 4 to cover and protect the liquid crystal panel 4.

In order to fix the cover plate 3 to the first support frame 1, the first elastic adhesive member 11 is provided between the first support surface S1 and the cover plate 3. Relative to the cover plate 3, the first elastic adhesive member 11 is disposed in a supported area of the cover plate 3, and the area is also an edge area of the cover plate 3, will not significantly shield a transparent area of the cover plate 3 and will not affect a display area of the display screen assembly.

Similarly, in order to fix the liquid crystal panel 4 to the first support frame 1, the second elastic adhesive member 12 is provided between the second support surface S2 and the liquid crystal panel 4. Relative to the liquid crystal panel 4, the second elastic adhesive member 12 is disposed in a supported area of the liquid crystal panel 4, and the area is also an edge area of the liquid crystal panel 4, will not significantly shield a transparent area of the liquid crystal panel 4 and will not affect the display area of the display screen assembly.

In order to prevent external dust, dirt, etc. from entering a space between the cover plate 3 and the liquid crystal panel 4 to affect or interfere with the display effect of the liquid crystal panel 4, the first sealing member 31 is provided between the outer side of the liquid crystal panel 4 and the cover plate 3, and the first sealing member 31 is located above the second support surface S2. In this case, the first sealing member 31 is disposed above the supported area of the liquid crystal panel 4 and located at the edge area of the liquid crystal panel 4, to effectively prevent dust and minimize the shielding of the display area of the liquid crystal panel 4.

The above technical solution provided in the present application achieves installation of the cover plate 3 and the liquid crystal panel 4 on the first support frame 1 by a simple structural form, and can prevent external dust from entering the space between the cover plate 3 and the liquid crystal panel 4, thereby fully ensuring a good display effect of the display screen assembly.

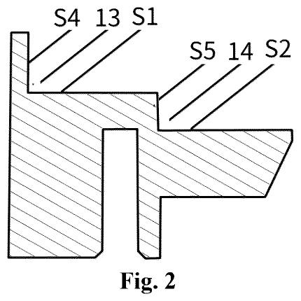

FIG. 2 is a schematic structural view of a first support frame of the display screen assembly according to an embodiment of the present application.

Preferably, with reference to FIG. 2 combined with FIG. 1, the first support frame 1 includes a first step portion 13 and a second step portion 14, the first step portion 13 is higher than the second step portion 14, the first support surface S1 is located at the first step portion 13, and the second support surface S2 is located at the second step portion 14.

The first support surface S1 supports the cover plate 3, and the second support surface S2 supports the liquid crystal panel 4, that is, the first step portion 13 supports the cover plate 3, and the second step portion 14 supports the liquid crystal panel 4. When a display screen assembly according to embodiments of the present application is produced, the liquid crystal panel 4 may be first mounted on the second support surface S2 of the second step portion 14, and then the cover plate 3 may be mounted on the first support surface S1 of the first step portion 13. Preferably, the first step portion 13 further includes a first vertical surface S4, a first buffer member 32 is provided between the first vertical surface S4 and the cover plate 3, and the first buffer member 32 is bonded to the first vertical surface S4.

In order to prevent glass cracking or breakage caused by the collision of the cover plate 3 with the first support frame 1 when the display screen assembly is impacted, the first buffer member 32 for preventing rigid contact between the cover plate 3 and the first support frame 1 is provided between the cover plate 3 and the first vertical surface S4 of the first step portion 13. The first buffer member 32 is bonded to the first vertical surface S4 of the first step portion 13 for fixing.

Preferably, the first buffer member 32 is a rubber pad or foam.

The rubber or foam can achieve a good buffer effect at a relatively low cost. The hardness of the first buffer member 32 ranges from 30 degrees to 70 degrees, which can achieve a balance between the buffer performance and strength of the buffer member, thereby on the one hand, fully absorbing deformation and on the other hand, achieving sufficient strength. The hardness of the first buffer member 32 is most preferably 50 degrees.

Preferably, with reference to FIG. 1 and FIG. 2, the second step portion 14 further includes a second vertical surface S5, a second buffer member 41 is provided between the second vertical surface S5 and the liquid crystal panel 4, and the second buffer member 41 is bonded to the second vertical surface S5.

In order to fully protect the liquid crystal panel 4 as the core component of the display screen assembly from damage due to rigid collision with the first support frame 1 when being impacted, the second buffer member 41 for preventing rigid contact between the liquid crystal panel 4 and the first support frame 1 is provided between the liquid crystal panel 4 and the second vertical surface S5 of the second step portion 14. The second buffer member 41 is fixed by bonding the second buffer member 41 to the second vertical surface S5 of the second step portion 14.

Preferably, the second buffer member 41 is a rubber pad or foam.

The hardness of the second buffer member 41 can be ranges from 30 degrees to 70 degrees, which can achieve a balance between the buffer performance and strength of the buffer member, so that the buffer member can, on the one hand, have sufficient buffer performance to fully absorb deformation, and on the other hand, have sufficient strength. The hardness of the second buffer member 41 is most preferably 50 degrees.

Preferably, the first sealing member 31 is foam.

Choosing foam as the first sealing member 31 can achieve good sealing performance at a relatively low cost. Further, the foam may have air permeability, which can facilitate smooth discharge of water vapor and moisture between the liquid crystal panel 4 and the cover plate 3, without remaining or accumulating between the cover plate 3 and the liquid crystal panel 4, thereby effectively avoiding the situation where the performance of the liquid crystal panel 4 is damaged or the display screen of the liquid crystal panel 4 cannot be clearly transmitted through the cover plate 3 due to the aforementioned reasons. When the humidity in the production environment is strictly limited, the foam may be airtight because no water vapor accumulates between the liquid crystal panel 4 and the cover plate 3.

Preferably, both the first elastic adhesive member 11 and the second elastic adhesive member 12 are double-sided adhesive tapes.

For ease of adhesion, both the first elastic adhesive member 11 and the second elastic adhesive member 12 are double-sided adhesive tapes. Further, in order to mitigate the adverse effects of deformation of the first support frame 1, the cover plate 3, etc. on the liquid crystal panel 4, and to avoid adverse situations such as light leakage, yellowing, or blackening during the use of the liquid crystal panel 4, the double-sided adhesive tape used in the present application may have certain buffer capacity, reflected in its hardness ranging from 30 to 70 degrees, to effectively buffer and offset the adverse effects of external structural deformation on the liquid crystal panel 4.

Preferably, a gap between the liquid crystal panel 4 and the cover plate 3 is not more than 1.26 mm.

In order to effectively avoid ghosting during external viewing, the present application limits the gap between the liquid crystal panel 4 and the cover plate 3. The gap not more than 1.26 mm ensures that the display screen assembly has a clear visual display effect.

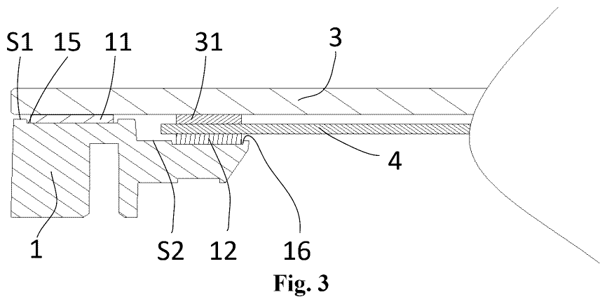

FIG. 3 is another schematic structural view of the display screen assembly according to an embodiment of the present application.

Preferably, with reference to FIG. 3, the first support surface S1 extends to an outer wall of the first support frame 1, and an outer edge of the cover plate 3 is coplanar with the outer wall of the first support frame 1.

In embodiments of the present application, the first support surface S1 extends to each outer wall of the first support frame 1, so that the cover plate 3 is placed on the first support frame 1, rather than inside the first support frame 1. Further, aligning the outer edge of the cover plate 3 with the outer wall of the first support frame 1 facilitates the alignment and positioning of the cover plate 3. Therefore, the present application simplifies the installation of the cover plate 3 relative to the first support frame 1 by a simple structural form, which can effectively improve the assembly efficiency of a display screen.

Preferably, with continued reference to FIG. 3, a first groove 15 is provided on the first support surface S1, a second groove 16 is provided on the second support surface S2, length directions of the first groove 15 and the second groove 16 are consistent with a length direction of a border of the first support frame 1, the first elastic adhesive member 11 is disposed in the first groove 15, and the second elastic adhesive member 12 is disposed in the second groove 16.

The first groove 15 and the second groove 16 can achieve a good pre-positioning effect on the first elastic adhesive member 11 and the second elastic adhesive member 12, so that the first elastic adhesive member 11 and the second elastic adhesive member 12 are easily and quickly disposed at predetermined positions.

Preferably, the first groove 15 has a width of not less than 2.5 mm and a depth of 0.2 to 0.6 mm; and the second groove 16 has a width of not less than 2.5 mm and a depth of 0.2 to 0.5 mm.

The width and depth of the first groove 15 can assist in ensuring that the first elastic adhesive member 11 has sufficient buffer performance and strength, to achieve the technical effect that the cover plate 3 is stable without abnormal noise or deformation after assembly.

The width and depth of the second groove 16 can assist in ensuring that the second elastic adhesive member 12 has a sufficient adhesive fixation effect on the liquid crystal panel 4.

Preferably, a relationship between an adhesive area S of the second elastic adhesive member 12 and a dimension A of the liquid crystal panel 4 satisfies: S≥343A, where S is in mm² and A is in inches.

In order to fully ensure the adhesive fixation effect of the liquid crystal panel 4, the adhesive area of the second elastic adhesive member 12 should be large enough. In the present application, the relationship between the adhesive area S of the second elastic adhesive member 12 and the dimension A of the liquid crystal panel 4 satisfies: S≥343A, which ensures that the second elastic adhesive member 12 has sufficient adhesive area.

On the premise of meeting the above adhesive area requirement, the length and width of the second elastic adhesive member 12 can be flexibly set. Further, on the premise of meeting the above adhesive area requirement, the second elastic adhesive member 12 may be connected end to end on four borders of the first support frame 1 to form a square, or segmented on each border.

In embodiments of the present application:
When the liquid crystal panel 4 is an 86-inch liquid crystal panel 4, the area of the second elastic adhesive member 12 is not less than 32485 mm² (S=377.7A);
When the liquid crystal panel 4 is a 75-inch liquid crystal panel 4, the area of the second elastic adhesive member 12 is not less than 25780 mm² (S=343.7A);
When the liquid crystal panel 4 is a 65-inch liquid crystal panel 4, the area of the second elastic adhesive member 12 is not less than 22310 mm² (S=343.2A); When the liquid crystal panel 4 is a 55-inch liquid crystal panel 4, the area of the second elastic adhesive member 12 is not less than 18890 mm² (S=343.5A).

Preferably, a relationship between a thickness H of the second elastic adhesive member 12 and the dimension A of the liquid crystal panel 4 satisfies: H>0.011A, where His in mm and A is in inches.

The elastic buffer effect of the second elastic adhesive member 12 depends on its sufficient thickness. In the present application, the relationship between the thickness H of the second elastic adhesive member 12 and the dimension A of the liquid crystal panel 4 satisfies: H≥0.011A, which ensures that the second elastic adhesive member 12 has sufficient thickness. In embodiments of the present application:

When the liquid crystal panel 4 is an 86-inch liquid crystal panel 4, the thickness of the second elastic adhesive member 12 is not less than 1.26 mm (H=0.0147A);

When the liquid crystal panel 4 is a 75-inch liquid crystal panel 4, the thickness of the second elastic adhesive member 12 is not less than 0.86 mm (H=0.0115A);

When the liquid crystal panel 4 is a 65-inch liquid crystal panel 4, the thickness of the second elastic adhesive member 12 is not less than 0.86 mm (H=0.0132A);

When the liquid crystal panel 4 is a 55-inch liquid crystal panel 4, the thickness of the second elastic adhesive member 12 is not less than 0.66 mm (H=0.012A).

Preferably, the first elastic adhesive member 11 has a Shore hardness of 30 to 70 degrees, and an adhesive is provided on a bottom surface or double sides of the first elastic adhesive member 11.

In order to ensure that the first elastic adhesive member 11 has sufficient strength and good buffer performance, the Shore hardness of the first elastic adhesive member 11 is preferably 30 to 70 degrees, and most preferably 50 degrees. In order to fix the first elastic adhesive member 11, the adhesive is provided on the bottom surface or both the bottom and top surfaces of the first elastic adhesive member 11.

Preferably, the gap between the liquid crystal panel 4 and the cover plate 3 is not more than 1.26 mm, and more preferably not more than 0.86 mm; the gap between the first support surface S1 and the cover plate 3 is 0.2 to 1 mm; and the height difference between the first support surface S1 and the second support surface S2 is 2.4 to 3.4 mm, which can greatly optimize the visual effect. Preferably, in order to achieve a superior visual display effect, a polarizing layer of the liquid crystal panel 4 has a haze of 20% to 30%, or both the inner and outer surfaces of the cover plate 3 have a haze of 3% to 20%.

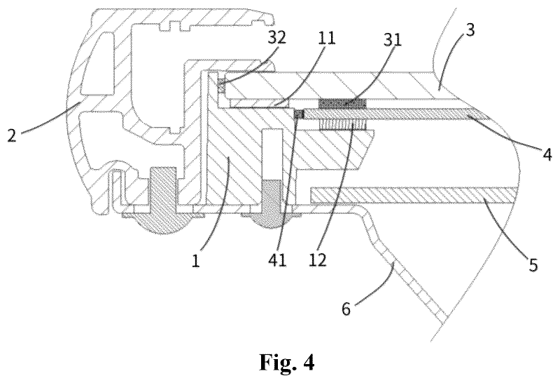

FIG. 4 is a schematic structural view of a display screen according to an embodiment of the present application.

In a second aspect, with reference to FIG. 4, the present application provides a display screen, including a second support frame 2, a backlight module 5, and the display screen assembly in the aforementioned embodiments of the present application, where the second support frame 2 surrounds peripheral edges and a back surface of the display screen assembly and is directly or indirectly fixedly connected to the first support frame 1; and the backlight module 5 is fixed to a bottom of the second support frame 2 or to a back of the first support frame 1.

The backlight module 5 emits light, so that the liquid crystal panel 4 can display images.

The second support frame 2 may be a complete integrated enclosure frame and includes a shell 6 at its bottom. In this case, the second support frame 2 can surround the peripheral edges and back surface of the display screen assembly, and the backlight module 5 can be fixed to the shell 6 of the second support frame 2.

The second support frame 2 may not have the shell 6. In this case, the backlight module 5 can be fixed to the back of the first support frame 1 in the display screen assembly. Those skilled in the art can understand that the above preferred solutions can be freely combined and superposed without conflict.

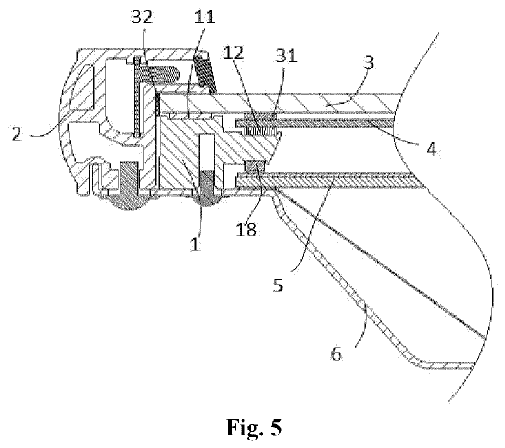

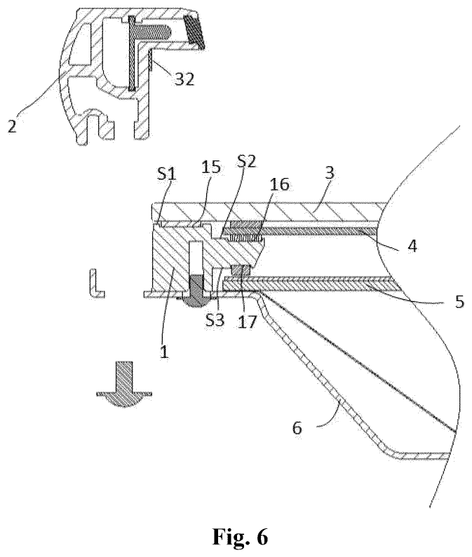

FIG. 5 is another schematic structural view of a display screen according to an embodiment of the present application. FIG. 6 is a partial exploded view of the display screen according to an embodiment of the present application.

In a third aspect, with reference to FIG. 5 and FIG. 6, the present application provides a display screen, including the display screen assembly in the aforementioned embodiments of the present application; the display screen in this embodiment of the present application further includes a second support frame 2, which surrounds the periphery of the first support frame 1 and presses outer surface edges of the cover plate 3; the second support frame 2 has an inner wall; the first support frame 1 is a square support frame composed of four borders, and the outer wall of the first support frame 1 and the outer edge of the cover plate 3 are opposite to the inner wall; the first buffer member 32 is provided between the inner wall and the outer edge of the cover plate 3.

The second support frame 2 surrounds the periphery of the first support frame 1 and presses the outer surface edges of the cover plate 3 to press the cover plate 3 supported by the first support frame 1. In addition, in some usage scenarios, the second support frame 2 may also be used for accommodating circuit boards, filter strips, infrared lights, etc. required for these usage scenarios.

Preferably, with continued reference to FIG. 5 and FIG. 6, the display screen in this embodiment of the present application further includes: a backlight module 5 located below the liquid crystal panel 4; and a shell 6, where the backlight module 5 is fixed between the shell 6 and the liquid crystal panel 4; the first support frame 1 further includes a third support surface S3 opposite to the second support surface S2; a third elastic adhesive member 18 is provided between the third support surface S3 and the backlight module 5; the third support surface S3 has a third groove 17, and at least a portion of the third elastic adhesive member 18 is located in the third groove 17; the distance between a bottom surface of the third elastic adhesive member 18 and an outer surface of the backlight module 5 is less than or equal to 0.4 mm.

To prevent abrasion of a surface member (usually an optical film) in the backlight module 5, the gap between the bottom surface of the third elastic adhesive member 18 and the outer surface of the backlight module 5 is 0 to 0.4 mm.

The third groove 17 is formed on the third support surface S3, and the top of the third elastic adhesive member 18 is located inside the third groove 17, which can achieve a pre-positioning effect on the third elastic adhesive member 18. The third elastic adhesive member 18 may be connected end to end on four borders of the first support frame 1 to form a square, or segmented on each border.

Preferably, a relationship between the dimension A of the liquid crystal panel 4 and a gap h between the liquid crystal panel 4 and the backlight module 5 satisfies: 9.2≤A/h≤18.5, where A is in inches and h is in mm.

Through the above settings, mutual abrasion caused by the joint of the liquid crystal panel 4 and backlight module 5 can be avoided, and the display screen can have a compact structure and an excellent display effect.

In embodiments of the present application:
When the liquid crystal panel 4 is an 86-inch liquid crystal panel 4, the gap between the liquid crystal panel 4 and the backlight module 5 is 6 to 8 mm (10.75≤A/h≤14.333);
When the liquid crystal panel 4 is a 75-inch liquid crystal panel 4, the gap between the liquid crystal panel 4 and the backlight module 5 is 5.5 to 7.5 mm (10≤A/h≤13.636);
When the liquid crystal panel 4 is a 65-inch liquid crystal panel 4, the gap between the liquid crystal panel 4 and the backlight module 5 is 5 to 7 mm (9.286≤A/h≤13);
When the liquid crystal panel 4 is a 55-inch liquid crystal panel 4, the gap between the liquid crystal panel 4 and the backlight module 5 is 3 to 5 mm (11≤A/h≤18.333).

Those skilled in the art should understand that the above embodiments are all illustrative but not restrictive. Different technical features appearing in different embodiments can be combined to achieve beneficial effects. Those skilled in the art should be able to understand and implement other modified embodiments of the disclosed embodiments after studying the drawings, description, and claims. In the claims, the term “comprise” does not exclude other apparatuses or steps; when an article is not modified by a quantifier, it is intended to include one or more articles, and may be exchanged with the “one or more articles” for use; and the terms “first” and “second” are used to denote names rather than to indicate any specific order. Any reference numerals in the claims should not be construed as limiting the scope of protection. The functions of a plurality of portions appearing in the claims can be implemented by a single hardware or software module. The appearance of some technical features in different dependent claims does not mean that these technical features cannot be combined to achieve beneficial effects.

What is claimed is:

1. A display screen assembly, comprising:
a cover plate;
a liquid crystal panel; and
a first support frame comprising a first support surface and a second support surface, wherein the first support surface is higher than the second support surface; the first support surface supports the cover plate, the second support surface supports the liquid crystal panel, and the cover plate covers an outer side of the liquid crystal panel; a first elastic adhesive member is provided between the first support surface and the cover plate, a second elastic adhesive member is provided between the second support surface and the liquid crystal panel, and a first sealing member is provided between the liquid crystal panel and the cover plate.

2. The display screen assembly according to claim 1, wherein the first support frame comprises a first step portion and a second step portion, the first step portion is higher than the second step portion, the first support surface is located at the first step portion, and the second support surface is located at the second step portion.

3. The display screen assembly according to claim 2, wherein the first step portion further comprises a first vertical surface, a first buffer member is provided between the first vertical surface and the cover plate, and the first buffer member is bonded to the first vertical surface.

4. The display screen assembly according to claim 3, wherein the first buffer member is a rubber pad or foam.

5. The display screen assembly according to claim 2, wherein the second step portion further comprises a second vertical surface, a second buffer member is provided between the second vertical surface and the liquid crystal panel, and the second buffer member is bonded to the second vertical surface.

6. The display screen assembly according to claim 5, wherein the second buffer member is a rubber pad or foam.

7. The display screen assembly according to claim 2, wherein the first sealing member is foam.

8. The display screen assembly according to claim 2, wherein both the first elastic adhesive member and the second elastic adhesive member are double-sided adhesive tapes.

9. The display screen assembly according to claim 2, wherein a gap between the liquid crystal panel and the cover plate is not more than 1.26 mm.

10. The display screen assembly according to claim 1, wherein the first support surface extends to an outer wall of the first support frame, and an outer edge of the cover plate is coplanar with the outer wall of the first support frame.

11. The display screen assembly according to claim 10, wherein a first groove is provided on the first support surface, a second groove is provided on the second support surface, and length directions of the first groove and the second groove are consistent with a length direction of the first support frame; the first elastic adhesive member is disposed in the first groove, and the second elastic adhesive member is disposed in the second groove.

12. The display screen assembly according to claim 11, wherein the first groove has a width of not less than 2.5 mm and a depth of 0.2 to 0.6 mm; and the second groove has a width of not less than 2.5 mm and a depth of 0.2 to 0.5 mm.

13. The display screen assembly according to claim 10, wherein a relationship between an adhesive area S of the second elastic adhesive member and a dimension A of the liquid crystal panel satisfies: S≥343A, wherein S is in mm² and A is in inches.

14. The display screen assembly according to claim 10, wherein a relationship between a thickness H of the second elastic adhesive member and the dimension A of the liquid crystal panel satisfies: H≥0.011A, wherein His in mm and A is in inches.

15. The display screen assembly according to claim 10, wherein the first elastic adhesive member has a Shore hardness of 30 to 70 degrees, and an adhesive is provided on a bottom surface or double sides of the first elastic adhesive member.

16. The display screen assembly according to claim 10, wherein a gap between the liquid crystal panel and the cover plate is less than or equal to 1.26 mm;
a gap between the first support surface and the cover plate is 0.2 to 1 mm;
a height difference between the first support surface and the second support surface is 2.4 to 3.4 mm; and
a polarizing layer of the liquid crystal panel has a haze of 20% to 30%, or both the inner and outer surfaces of the cover plate have a haze of 3% to 20%.

17. A display screen, comprising:
the display screen assembly according to claim 1;
a second support frame surrounding peripheral edges and a back surface of the display screen assembly, wherein the second support frame is directly or indirectly fixedly connected to the first support frame; and
a backlight module fixed to a bottom of the second support frame or to a back of the first support frame.

18. A display screen, comprising:
the display screen assembly according to claim 10;
a second support frame surrounding the periphery of the first support frame and pressing outer surface edges of the cover plate, wherein the second support frame has an inner wall; the first support frame is a square support frame composed of four borders, and the outer wall of the first support frame and the outer edge of the cover plate are opposite to the inner wall; the first buffer member is provided between the inner wall and the outer edge of the cover plate.

19. The display screen according to claim 18, further comprising:
a backlight module located below the liquid crystal panel; and
a shell, wherein the backlight module is fixed between the shell and the liquid crystal panel;
wherein the first support frame further comprises a third support surface opposite to the second support surface; a third elastic adhesive member is provided between the third support surface and the backlight module; the third support surface has a recessed portion, and at least a portion of the third elastic adhesive member is located in the recessed portion; the distance between a bottom surface of the third elastic adhesive member and an outer surface of the backlight module is less than or equal to 0.4 mm.

20. The display screen according to claim 19, wherein a relationship between the dimension A of the liquid crystal panel and a gap h between the liquid crystal panel and the backlight module satisfies: 9.2≤A/h≤18.5, wherein A is in inches and h is in mm.
